(19) United States
(12) Patent Application Publication
(10) Pub. No.: US 2019/0265880 A1
(43) Pub. Date: Aug. 29, 2019

(54) Swipe-Board Text Input Method

(71) Applicant: Tsimafei Sakharchuk, Minsk (BY)

(72) Inventor: Tsimafei Sakharchuk, Minsk (BY)

(21) Appl. No.: 16/280,308

(22) Filed: Feb. 20, 2019

Related U.S. Application Data
(60) Provisional application No. 62/634,216, filed on Feb. 23, 2018.

(51) Int. Cl. G06F 3/0488; G06F 3/0484

(52) U.S. Cl. CPC G06F 3/04883; G06F 3/04845

(57) ABSTRACT

Swipe-Board Text Input Method is a method of inputting text characters by recognizing swipe action on a part of a touchscreen device or touch-sensitive surface. Each part provides a number of directions that could be handled by it and is clear for a user. If a number of such parts are used, most of existing alphabets could be covered: total number of directions is grater then characters in alphabet. In other words, if user makes a swipe on some surface, text character is inserted into the text field. Swipe-Board embodiment should be great alternative for a keyboard in different areas like mobile devices, TV, etc.

### BACKGROUND

### Field of the Invention

Swipe-Board is a method of generating text messages by detecting swipe actions (and their direction) on any surface or part of the surface that supports recognition of touch events, so it requires less surface space to be dedicated to text inputting, increases overall accuracy and provides additional features: eyes-free text entry, transparent/empty detection surface, adjustments to particular user (size and placement), accessibility support, text input on smart watch.

### Description of the Related Art

Traditional text input requires a hardware or software keyboard. This approach works well for Personal Computers, but for mobile and TV devices it is not as comfortable for end users. Disadvantages are described below.

In case of mobile devices, software keyboard takes a large part of a screen, it is hard to input text with one hand, it is hard to input text accurately, as each key is too small for finger size and one has to hold the device on the bottom edge. Also, there is no way to input text without looking at the software keyboard. One more issue is that on the landscape mode software keyboard usually takes almost the whole screen.

For TV devices, text inputting software keyboard requires user to select characters by using left, right, up, down TV remote controls to move selection through keyboard which takes a lot of actions (key presses) to enter every letter. And there is no comfortable solution to input text symbol by single movement action with TV remote. The best working solution for TV text inputting is a hardware keyboard, but this is an extra device, which is usually much bigger than regular TV remote.

There is a way of voice recognition for text inputting, but it still makes many mistakes, especially for non-native speakers. Also, it is impossible to input words that are not in recognition database, so any “slang” words cannot be entered. Another disadvantage of this approach is that people around will hear everything that user wants to input, that is not comfortable in public places.

One more alternative approach is Hand Writing Recognition. A major issue with this approach is that different people have different writing “style” and existing solutions have poor adoption skill to work well.

Other approaches like gestures recognition require users to keep a lot of information in their memory, which is not trivial for an average user.

### SUMMARY

In general, a “Swipe-Board” recognizes swipe events on a part of a surface (collectively referred to herein as a “segment”), figures out the user's intention about direction (certain embodiments of the present invention include, but are not limited to left, right, up, down, up-left, up-right, down-left or down-right—8 directions, which is optimal for current level of technologies of swipe recognition) and places text symbol into text field based on direction and segment that recognized the swipe action, according to the segments/directions-characters map (collectively referred to herein as a “layout”).

Any touch-recognizing surface could be used. Ex.: Mobile phone screen, TV remote control touchpad, Laptop touchpad, etc.

Swipes over more than one segment could be used for global operations like: entering upper-cased input, change input method, submit action (enter key emulation), auto-suggestions manipulations, etc.

Taps on segments can be used as well for the most popular actions like: insert space symbol, backspace, entering numbers/special symbol's mode, switching layouts, etc. Long press on a segment could be used for actions like: fast delete, recognition surface moving and resizing, cursor moving, etc.

“Swipe-Board” also provides eye-free text input features, could be transparent (for mobile app case), doesn't require a display panel (touchpad case). This feature could be used to help people with eye-related disabilities to input text.

As a summary of mentioned above, Swipe-Board Text Input Method supports the same features as existing text input solutions have and in addition provides the following improvements: requires less surface space dedicated to text inputting, supports adjustment for a particular user, provides eye-free text inputting, supports text inputting for people with disabilities, make possible to enter text character by a single action on TV remote control.

### BRIEF DESCRIPTION OF THE DRAWINGS

FIG. 1 illustrates Mobile application embodiment

FIG. 2 illustrates Segment with Swipe action description

FIG. 3 illustrates Segment with 8 directions

FIG. 4 illustrates entire Swipe-Board created from 4 segments

FIG. 5 illustrates how current layout information may be displayed to a user

FIG. 6 illustrates a transparent Swipe-Board mobile application embodiment

FIG. 7 illustrates Swipe-Board in a landscape view as a mobile application embodiment

FIG. 8 illustrates Swipe-Board as a TV text input embodiment

FIG. 9 illustrates Swipe-Board as car eye-free text inputting, located at the car steering wheel

### DETAILED DESCRIPTION

### 1. Introduction

Swipe-Board Text Input Method is just a method that may have various embodiments described below but is not limited to it. In general, the idea is to use a swipe (defined below) user action on the touch recognizing surface and convert it to a particular text character based on swipe direction and segment (defined below).

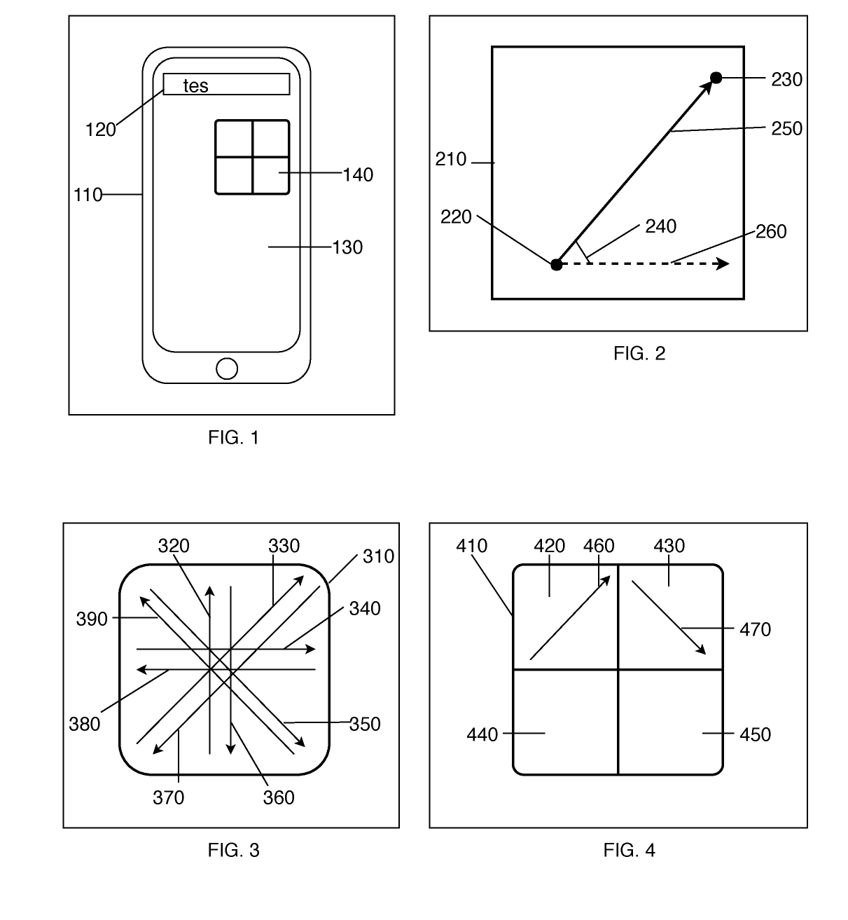

FIG. 1 illustrates how Mobile application embodiment may look

### 2. Definitions

As used herein, term Swipe means user action made by a finger or a writing implement (below, finger is used as an example) that includes three steps:
1. Touch the surface (210) at some point (220)
2. Move the finger sliding above the surface
3. Remove the finger at other point (230) so it is not touching the surface anymore.

Swipe Direction is defined by the angle (240) between the line (250) connecting point 220 and point 230 and the line that is selected as zero-direction (260). Any direction could be chosen as zero-direction, but it should remain the same for all swipes.

Tap is defined as an action of touching the surface by a finger or a writing implement for a short period of time (for example less than 0.5 seconds) without sliding on the surface.

Long press is defined as an action of touching the surface by a finger or a writing implement for a long period of time (for example more than 0.5 seconds). Sliding on the surface is possible during the long press.

Segment (210) is defined as a part of surface that is able to recognize swipe, tap and long press actions on it.

Every swipe equals a text symbol that will be placed in the text field as a result of the user action based on the swipe direction and the segment that detects the swipe.

Layout is defined as matching map between swipe directions on segments and the text character that will be inserted into the text field. Layouts support is needed to provide ability to use different alphabets, numbers, punctuation symbols, etc.

Board is defined as a part of touch-recognizing surface allocated for user interactions according to the Swipe-Board text input method. Board includes Segments.

### 3. Preferred Embodiment

### 3.1. General

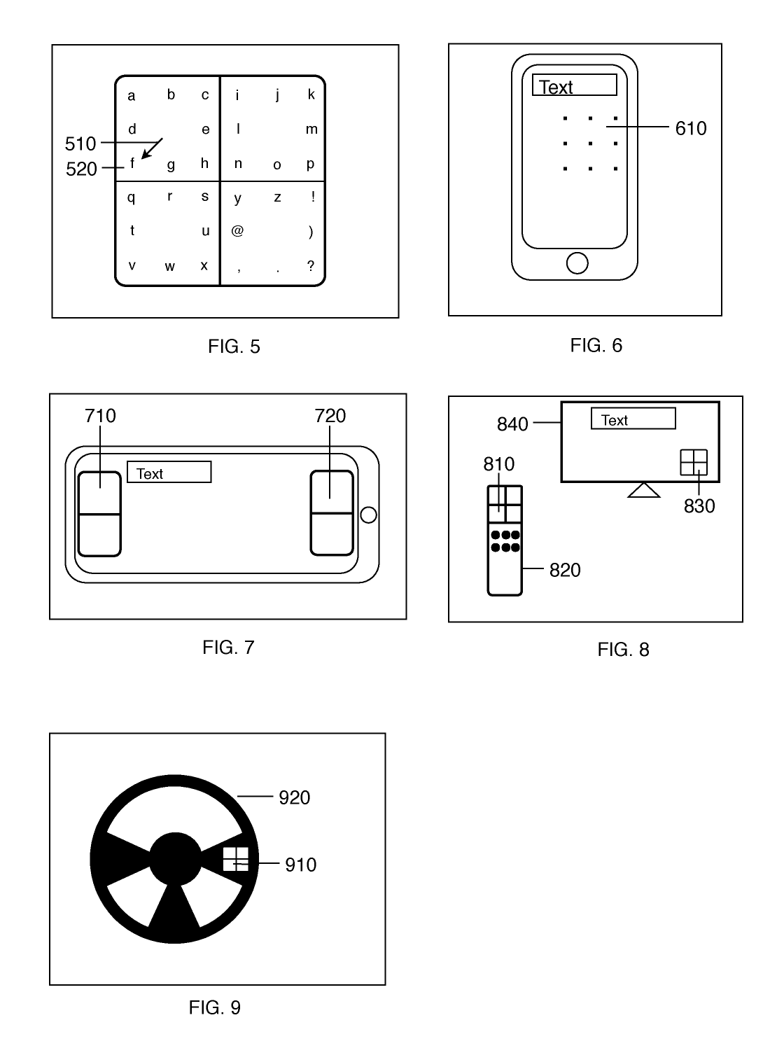

Considering existing touch events recognition capabilities, the most preferred embodiment is:
1. recognize 8 swipe directions (FIG. 3) per segment (310): up (320), up-right (330), right (340), down-right (350), down (360), down-left (370), left (380) and up-left (390)
2. use 4 segments of Board (410) aligned as shown at FIG. 4: Segment 1 (420), Segment 2 (430), Segment 3 (440) and Segment 4 (450)
3. Current layout is visible for a user as it is shown at FIG. 5: direction (510) from the center of the segment to the character (520) will input that character (520)

So, in current implementation, for example, if the user makes an up-right swipe (460) on the Segment 1 (420), letter “c” will be inserted into the text field. If the user makes a down-right swipe (470) on the Segment 2 (430), letter “p” will be inserted into the text field. Similar experience is actual for all swipe direction on every segment.

Tap actions:
1. Segment 1 (420) Tap: “ ” (space) symbol is inserted into the text field
2. Segment 2 (430) Tap: the symbol to the left from the cursor is removed from the text field (backspace functionality)
3. Segment 3 (440) Tap: Layout is changed to Cyrillic—just an example, layouts should be configurable by a user
4. Segment 4 (450) Tap: Layout is changed to Numeric and punctuation—just an example, layouts should be configurable by a user

### Global Actions:

1. Swipe starts from Segment 3 (440) and ends on Segment 1 (430): Layout changes to Upper-cased variant for the active alphabet
2. Swipe starts from Segment 1 (420) and ends on Segment 3 (440): Layout changes to Upper-cased variant for the active alphabet
3. Swipe starts from Segment 2 (430) and ends on Segment 2 (430): Submit action happens on the text field. Actual result of this action depends on the Operation System and Application that uses Swipe-Board for text input.

Long press actions:
1. Long press action on Segment 1 (420): If user slides the finger over the surface while pressed, size of the Board changes accordingly, so user can adjust the size to be the most comfortable. Actual for Mobile Application embodiment.
2. Long press action on Segment 2 (430): While pressed text symbols to the left of cursor continue removing, so user is able to remove a big part of text with just a single action.
3. Long press action on Segment 3 (440): While pressed cursor is moving through the text in the same direction as user moves his finger, so user can place a cursor in correct place with minimal effort. The number of text symbols passed by cursor is based on the distance passed by the user's finger while sliding.
4. Long press action on Segment 4 (450): While pressed, the Board gets adhered to the user's finger, so user is able to drag it in the place that is comfortable in particular moment. Actual for Mobile Application embodiment.

### 3.2. Mobile Application Preferred Embodiment

In the Mobile Application case, a part of the touch-screen (130) of the Mobile Device (110) should be allocated for the Board (140) (FIG. 1). It should become visible once user clicks on the text field (120) or other conditions that are considered by operation system as situation that assumes text input. Swipe-Board mobile application should have configuration interface, so user is able to manage important Swipe-Board features, for example set of layouts, etc.

User should be able to resize the Board to match personal comfort conditions (for example finger size, etc.) as described above in 3.1.

User should be able to move the Board over the screen to the place that is more comfortable for particular situation as described in 3.1. (for example, to not have the Board overlap some important content that should be visible while inputting text, etc.)

When user is familiar enough with some layout, he/she may have an option to have the Board transparent, so he/she could see the content through it. So, if user remembers all swipe-character matches for a particular layout, this feature will bring him/her a new experience. User will be able to keep eyes on more important things, like, for example, text he/she is inputting. Segment's borders could be marked with dots (610) like it is shown on the FIG. 6, so user still knows where Swipe-Board is. Various sounds or/and vibrations could be used to indicate which swipe action was done, which text character was inserted into the text field. This may be needed to make clear for the user that text character placed into the text field is the same that he/she intended to.

When Mobile Device is in a Landscape view, Board's segments (710 and 720) may be separated to the opposite screen sides like it is shown on the FIG. 7. So, it is more comfortable to input text with two hands.

### 3.3. TV Device Preferred Embodiment

In TV device case, touch panel (810) of TV remote control (820) could be allocated for the Board when TV operation system considers text input. Current Board's layout (830) could be displayed on TV screen (840), as TV's remote touch panel (810) is usually not a display. For example, like it is shown on the FIG. 8. In current embodiment user is able to input text with a single action per character.

### 3.4. Accessibility Embodiment

Swipe-Board text input method may be useful for people with eye-related disabilities because it doesn't require accuracy in user interactions and the size of the Board could be adjusted for a particular user.

### 3.5. Other Potential Embodiments

Swipe-Board could be a possible solution for situations where text inputting was not considered previously at all.

For example, if touch panel with the Board (910) is located on the car steering wheel (920), driver will be able to input text without leaving eyes off the road.

What is claimed is:

1. Swipe-Board Text Input Method is a method of inputting text by detecting of a swipe action direction on the part of a touch-recognizing surface and selecting the text character to input from the directions-characters map.

2. The method from claim 1 is extendable by adding as much surface parts as needed for a particular embodiment

3. The method from claim 1 implemented as a software that detects swipe actions on a touch-recognizing surface to provide text input

4. The method from claim 1 wherein the improvement comprises requiring less space of the surface taken for text inputting, by using swipe action instead of tap on particular label to figure out user intention regarding to text character to be input into the text field

5. The method from claim 1 wherein the improvement comprises less strict accuracy requirements from a user, by having swipe action on a big element instead of tap/click on a small element

6. The method from claim 1 wherein the improvement comprises ability to adjust sizes of elements for a particular user

7. The method from claim 1 wherein the improvement comprises support of eyes-free text entry

8. The method from claim 1 wherein the improvement comprises support of text input for people with disabilities

9. The method from claim 1 wherein the improvement comprises possibility to use TV remote touch surface for text inputting

10. The method from claim 1 wherein the improvement comprises possibility of text inputting for a car driver without taking his eyes off the road by using a touch recognizing surface on a steering wheel.

11. The method from claim 1 wherein the improvement comprises possibility to create a separate device with a touch-recognizing surface to replace hardware keyboard for text inputting.

12. The method from claim 1 wherein the improvement comprises possibility to create a mobile app that will use a part of a screen of a mobile device (like mobile phone, smart watch, etc.) and that will replace a software keyboard on a system level.

13. The method from claim 1 wherein the improvement comprises ability to separate touch-recognizing surface parts to opposite sides of a surface to make two-hands text input comfortable and faster
